(19) United States
(12) Patent Application Publication
(10) Pub. No.: US 2026/0311401 A1
(43) Pub. Date: Oct. 8, 2026

(54) PAGE GENERATION METHOD, APPARATUS, AND DEVICE, AND STORAGE MEDIUM

(71) Applicant: Douyin Vision Co., Ltd., Beijing (CN)

(72) Inventors: Haihui Bai, Beijing (CN); Hao Ai, Beijing (CN); Sha Yu, Beijing (CN); Tianlun Ge, Beijing (CN); Kun Feng, Beijing (CN)

(21) Appl. No.: 19/481,870

(22) PCT Filed: Jul. 26, 2024
(86) PCT No.: PCT/CN2024/107945

§ 371 Date: Nov. 5, 2025

(30) Foreign Application Priority Data
Mar. 11, 2024 (CN) 202410276431.4

(51) Int. Cl. G06T 11/60

(52) U.S. Cl. CPC G06T 11/60

(57) ABSTRACT

The present disclosure provides a page generation method, apparatus, and device, and a storage medium. The method includes: receiving target description text; obtaining first description content generated based on the target description text; converting the first description content to second description content based on a preset relationship between a first target description specification and a second target description specification; and generating a target page based on the second description content.

### CROSS-REFERENCE TO RELATED APPLICATION(S)

The present disclosure is a national stage application filed under 35 U.S.C. 371 based on International Patent Application No. PCT/CN2024/107945, filed Jul. 26, 2024, which claims the priority from the CN patent application No. 202410276431.4 filed with the China National Intellectual Property Administration on Mar. 11, 2024, the contents of which are incorporated herein by reference in their entireties.

### FIELD

The present disclosure relates to the field of data processing, and in particular, to a page generation method, apparatus, and device, and a storage medium.

### BACKGROUND

Currently, page designers usually complete the construction of pages by dragging components on low-code applications.

### SUMMARY

Embodiments of the present disclosure provide a page generation method, apparatus, and device, and a storage medium.

According to a first aspect, the present disclosure provides a page generation method. The method includes:
receiving target description text;
obtaining first description content generated based on the target description text, wherein the first description content conforms to a first target description specification;
converting the first description content to second description content based on a preset relationship between the first target description specification and a second target description specification, wherein the second description content conforms to the second target description specification; and
generating a target page based on the second description content.

In an optional implementation, obtaining the first description content generated based on the target description text includes:
sending the target description text to a server, wherein a target model is deployed on the server, the target model is used for generating the first description content based on the target description text, and the target model is obtained through training using samples conforming to the first target description specification.

In an optional implementation, converting the first description content to the second description content based on the preset relationship between the first target description specification and the second target description specification includes:
converting a first description unit in the first description content to first page component description content based on a preset relationship between a description unit corresponding to the first target description specification and page component description content corresponding to the second target description specification, wherein the first page component description content is used for describing a corresponding page component according to the second target description specification; and
determining the second description content based on the first page component description content.

In an optional implementation, generating the target page based on the second description content includes:
displaying an initial page based on the second description content;
receiving a page edit operation for the initial page; and
generating the target page corresponding to the initial page based on the page edit operation.

In an optional implementation, a plurality of page components are displayed on the initial page, and receiving the page edit operation for the initial page includes:
receiving a component edit operation for the plurality of page components on the initial page, wherein the component edit operation includes at least one of a component addition operation, a component deletion operation, and a component adjustment operation.

In an optional implementation, a plurality of page components are displayed on the initial page, and receiving the page edit operation for the initial page includes:
receiving an adjustment operation for a target variable of a target page component in the plurality of page components, wherein the target variable is used for displaying the target page component.

In an optional implementation, before receiving the target description text, the method further includes:
determining a target application object; and
correspondingly, receiving the target description text includes:
   receiving target description text generated for the target application object, wherein the target description text is used for describing the target application object;
   or, receiving target description text input by a user.

In an optional implementation, before obtaining the first description content generated based on the target description text, the method further includes:
determining a page display platform, wherein the page display platform is used for displaying the target page; and
correspondingly, obtaining the first description content generated based on the target description text includes:
   obtaining first description content generated based on the target description text and the page display platform.

According to a second aspect, the present disclosure further provides a page generation apparatus. The apparatus includes:
a first receiving module configured to receive target description text;
a first obtaining module configured to obtain first description content generated based on the target description text, wherein the first description content conforms to a first target description specification;
a content conversion module configured to convert the first description content to second description content based on a preset relationship between the first target description specification and a second target description specification, wherein the second description content conforms to the second target description specification; and
a first generation module configured to generate a target page based on the second description content.

According to a third aspect, the present disclosure provides a computer-readable storage medium having instructions stored therein, wherein the instructions, when run on a terminal device, cause the terminal device to implement the method described above.

According to a fourth aspect, the present disclosure provides a page generation device. The page generation device includes: a memory, a processor, and a computer program that is stored on the memory and may be run on the processor, wherein the processor, when executing the computer program, implements the method described above.

According to a fifth aspect, the present disclosure provides a computer program product including a computer program/instructions that, when executed by a processor, cause the method described above to be implemented.

### BRIEF DESCRIPTION OF THE DRAWINGS

The abovementioned and other features, advantages, and aspects of embodiments of the present disclosure become more apparent with reference to the following specific implementations and accompanying drawings. Throughout the accompanying drawings, the same or similar reference numerals denote the same or similar elements. It should be understood that the accompanying drawings are schematic and that parts and elements are not necessarily drawn to scale.

FIG. 1 is a flowchart of a page generation method according to an embodiment of the present disclosure;

FIG. 2 is a schematic diagram of an interactive page according to an embodiment of the present disclosure;

FIG. 3 is a schematic diagram of another interactive page according to an embodiment of the present disclosure;

FIG. 4 is a schematic diagram of another interactive page according to an embodiment of the present disclosure;

FIG. 5 is a schematic structural diagram of a page generation apparatus according to an embodiment of the present disclosure; and

FIG. 6 is a schematic structural diagram of a page generation device according to an embodiment of the present disclosure.

### DETAILED DESCRIPTION OF EMBODIMENTS

For a clearer understanding of the above objectives, features and advantages of the present disclosure, the solutions of the present disclosure will be further described below. It should be noted that the embodiments of the present disclosure and features in the embodiments may be combined with each other without conflict.

Many specific details are set forth in the following description to facilitate a full understanding of the present disclosure. However, the present disclosure may also be implemented in other ways different from those described herein. Apparently, the embodiments in this specification are only some rather than all of the embodiments of the present disclosure.

Currently, page designers usually complete the construction of pages by dragging components on low-code applications. However, for non-professionals, the manner described above also has the cost of understanding and skilled use for the low-code applications.

Therefore, how to reduce professional requirements for page design to enable non-professionals to complete page generation is a technical problem that urgently needs to be solved currently.

In order to solve the technical problem described above, embodiments of the present disclosure provide a page generation method, apparatus, and device, and a storage medium.

Therefore, an embodiment of the present disclosure provides a page generation method, specifically including: receiving target description text; obtaining first description content generated based on the target description text, wherein the first description content conforms to a first target description specification; converting the first description content to second description content based on a preset relationship between the first target description specification and a second target description specification, wherein the second description content conforms to the second target description specification; and generating a target page based on the second description content.

In this embodiment of the present disclosure, a page generation process is completed by means of generating the first description content based on the target description text and then converting the first description content to the second description content based on which the target page can be generated. It can be learned that, in this embodiment of the present disclosure, a user may complete the generation of the target page simply by inputting the target description text, and there is almost no requirement for the professionalism of page design.

In addition, the manner of intelligently generating pages in this embodiment of the present disclosure obviously improves the efficiency of page generation as compared to the method for completing the construction of pages simply by dragging components in the prior art.

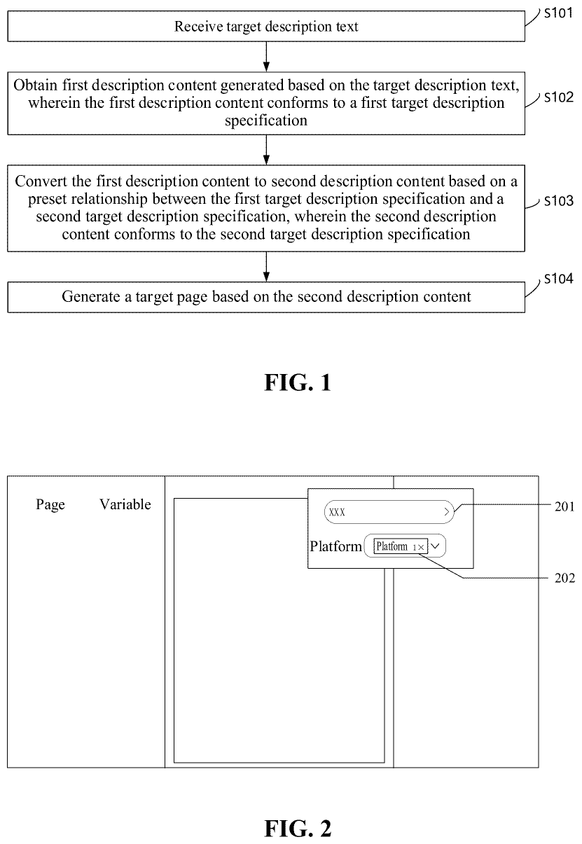

Specifically, an embodiment of the present disclosure provides a page generation method. FIG. 1 is a flowchart of a page generation method according to an embodiment of the present disclosure. The page generation method specifically includes:

S101: Receive target description text.

The page generation method provided in this embodiment of the present disclosure may be applied to a client. Specifically, the client may be deployed on a terminal such as a smartphone, a tablet computer, or a desktop computer.

In this embodiment of the present disclosure, the target description text may include a text segment or one or more keywords. Specific content and a description manner of the target description text are not limited in this embodiment of the present disclosure.

In an optional implementation, manners of receiving the target description text may include: a manner of inputting description text into an input box by a user. Specifically, the description text input by the user is received, and the description text is determined as the target description text.

In another optional implementation, the target description text may alternatively be intelligently generated by a system. Specifically, corresponding description text may be intelligently generated based on a predetermined target application object as the target description text, wherein the target description text may be used for describing a feature of the target application object. Specifically, the target application object is an application to which a target page belongs, that is, the target page is generated for the target application object.

In an optional implementation, the user may select any application object on an interactive page as the target application object, and then, after a page construction operation is triggered for the target application object, the description text corresponding to the target application object, namely the target description text, is displayed in the input box. The target description text is automatically generated based on the feature of the target application object, so as to be used for generating the target page corresponding to the target application object.

In another optional implementation, after the target description text that is automatically generated based on the target application object is received, the user may further manually modify the target description text in the input box.

S102: Obtain first description content generated based on the target description text.

The first description content conforms to a first target description specification.

In this embodiment of the present disclosure, the first description content may include a plurality of description units, and each description unit is generated based on the target description text. Specifically, the first description content may include description content that is generated based on the target description text and that conforms to a predefined first target description specification, such as code content conforming to a code format.

The first target description specification may be any predefined content description specification, such as a code format. That is, the first description content is description content conforming to the first target description specification.

In an optional implementation, after the target description text is received, the received target description text may be input into a target model deployed on a server. The target description text is processed by the target model, and the first description content conforming to the first target description specification is output and returned to the client from the server. That is, the first description content may be generated based on the target description text in a manner of a large model.

The target model may be a model that is obtained through training using samples conforming to the first target description specification. A specific model type, a construction manner, etc. are not limited in this embodiment of the present disclosure.

In an optional implementation, first, a model is constructed based on the predefined first target description specification to ensure that the constructed model meets a requirement of the first target description specification; and then, the constructed model is trained using samples conforming to the first target description specification to obtain a trained model. In a model training process, some samples conforming to the first target description specification are used for model verification to adjust a parameter of the model, so that the finally obtained target model better meets a requirement for generating the first description content based on the target description text in this embodiment of the present disclosure.

In actual application, after the target description text is received, in order to enable the generated first description content to be more adapted to an application platform thereof, the implementation of the present disclosure further supports determining of a page display platform, wherein the page display platform is used for displaying the target page.

In an optional implementation, after the target description text is received, the user selects the page display platform on the interactive page based on a requirement, and then, first description content generated based on the target description text and the page display platform is obtained. Specifically, the target description text and the page display platform may be input into the target model deployed on the server. The target description text and the page display platform are processed by the target model, and the first description content conforming to the first target description specification is output and returned to the client from the server.

S103: Convert the first description content to second description content based on a preset relationship between the first target description specification and a second target description specification.

The second description content conforms to the second target description specification.

In this embodiment of the present disclosure, the second target description specification may be a code format. The second description content may include description content conforming to the second target description specification. Specifically, the second description content is used for describing a page, that is, a corresponding page may be displayed based on the second description content. The second description content may include page component description content, and each page component on the page may be displayed based on each piece of page component description content in the second description content. The second target description specification may be an HTML code format for describing a web page, etc.

In this embodiment of the present disclosure, the preset relationship between the first target description specification and the second target description specification is predefined, and the first description content conforming to the first target description specification may be converted to the second description content conforming to the second target description specification based on the preset relationship.

In an optional implementation, a preset relationship between a description unit corresponding to the first target description specification and page component description content corresponding to the second target description specification is predefined.

Specifically, a first description unit in the first description content is converted to first page component description content based on the preset relationship between the description unit corresponding to the first target description specification and the page component description content corresponding to the second target description specification. The first page component description content is used for describing a corresponding page component. Specifically, the corresponding page component may be described according to the second target description specification. Then, after the description units in the first description content are converted to corresponding page component description content, the second description content including the page component description content is obtained.

S104: Generate a target page based on the second description content.

In this embodiment of the present disclosure, after the first description content is converted to the second description content conforming to the second target description specification, the target page is generated based on the second description content. A plurality of page components, such as a text component, a list component, and a drop-down box component, may be displayed on the target page, to form the target page.

In an optional implementation, the page generated based on the second description content may be an initial page, and the initial page may be edited based on a user requirement, to finally obtain the target page meeting the requirement. Specifically, after the first description content is converted to the second description content based on the preset relationship between the first target description specification and the second target description specification, the initial page is generated based on the second description content, and the initial page is displayed; and then, a page edit operation for the initial page is received, and the target page corresponding to the initial page is generated based on the page edit operation.

In an optional implementation, a plurality of page components are displayed on the initial page, and the page edit operation for the initial page may specifically include a component edit operation for the plurality of page components on the initial page. Specifically, when the initial page is displayed, the component edit operation for a target component in the plurality of page components on the initial page is received. The component edit operation may include at least one of a component addition operation, a component deletion operation, and a component adjustment operation.

The component addition operation may be specifically adding a component to the initial page, specifically by dragging a component in a component region to the initial page. The component deletion operation may be triggered to delete a component. Specifically, a component may be selected, and the component deletion operation is triggered for deletion. The component adjustment operation may be specifically adjusting a location of a component, etc.

In another optional implementation, a plurality of page components are displayed on the initial page, and the page edit operation for the initial page may specifically include an adjustment operation for a target variable in the plurality of page components on the initial page. Specifically, the adjustment operation for the target variable of the target page component in the plurality of page components on the initial page is received. Specifically, the adjustment operation for the target variable is, for example, adding a target variable or re-editing an existing variable of the component. Specifically, for example, a size, style, font, etc. of the page component are adjusted, and the target page component is redisplayed based on the target variable.

In the page generation method provided in this embodiment of the present disclosure, the target description text is received; the first description content generated based on the target description text is obtained, wherein the first description content conforms to a first target description specification; the first description content is converted to the second description content based on the preset relationship between the first target description specification and the second target description specification, wherein the second description content conforms to the second target description specification; and the target page is generated based on the second description content.

In this embodiment of the present disclosure, a page generation process is completed by means of generating the first description content based on the target description text and then converting the first description content to the second description content based on which the target page can be generated. It can be learned that, in this embodiment of the present disclosure, a user may complete the generation of the target page simply by inputting the target description text, and there is almost no requirement for the professionalism of page design.

In addition, the manner of intelligently generating pages in this embodiment of the present disclosure obviously improves the efficiency of page generation as compared to the method for completing the construction of pages simply by dragging components in the prior art.

In order to facilitate the understanding of the embodiments described above, the page generation method provided in the present disclosure is described with reference to schematic diagrams in the embodiments of the present disclosure. Refer to FIG. 2 to FIG. 4. FIG. 2 is a schematic diagram of an interactive page according to an embodiment of the present disclosure.

First, the user selects the target application object on the interactive page, then, an input box 201 is displayed when the page construction operation for the target application object is received, and the user may input the target description text in the input box.

Then, after the target description text is received, the user selects a page display platform 202 on the interactive page based on a requirement, the received target description text and the page display platform are input into the target model deployed on the server, the target description text and the page display platform are processed by the target model, and the first description content conforming to the first target description specification is output and returned to the client from the server.

Then, the client converts the first description unit in the first description content to the first page component description content based on the preset relationship between the description unit corresponding to the first target description specification and the page component description content corresponding to the second target description specification. After the description units in the first description content are converted to corresponding page component description content, the second description content including the page component description content is obtained.

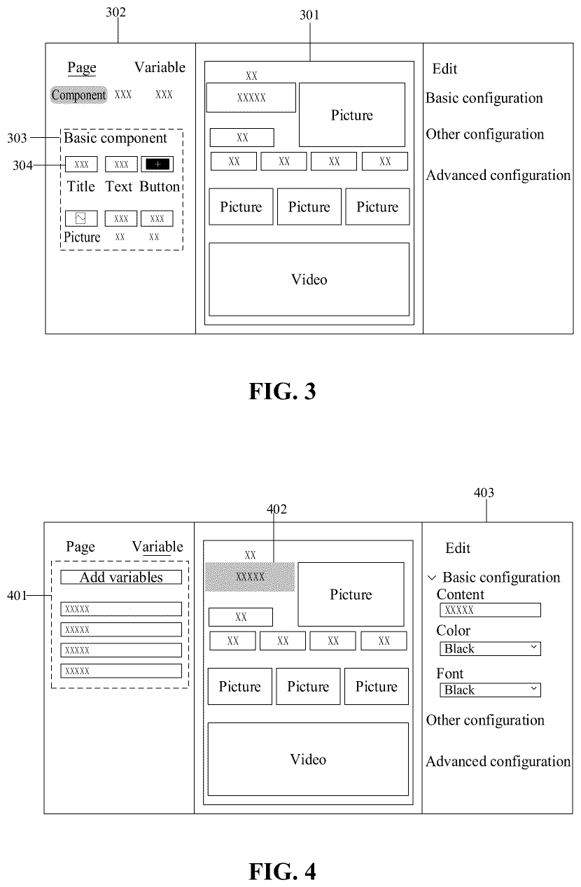

After the first description content is converted to the second description content conforming to the second target description specification, the initial page is generated based on the second description content. FIG. 3 is a schematic diagram of an interactive page according to an embodiment of the present disclosure. The interactive page has an initial page 301, and a plurality of page components including a picture component, a text component, etc. are displayed on the initial page. Then, the user may perform a component edit operation on the initial page based on a requirement, such as a component region 302 on the interactive page shown in FIG. 3. The user enters a component edit region 303 by triggering a component control, and the user may drag a component 304 to the initial page, to complete the component addition operation.

In addition, the user may further perform a target variable adjustment operation on the page component displayed on the initial page. FIG. 4 shows an interactive page according to an embodiment of the present disclosure. On the interactive page, the user enters a variable adjustment region 401 by triggering a variable control. The user may select a page component 402 on the initial page to add a variable for the page component 402, and may further perform a reconfiguration operation on the page component, such as a component configuration region 403, to achieve the configuration of the page component 402.

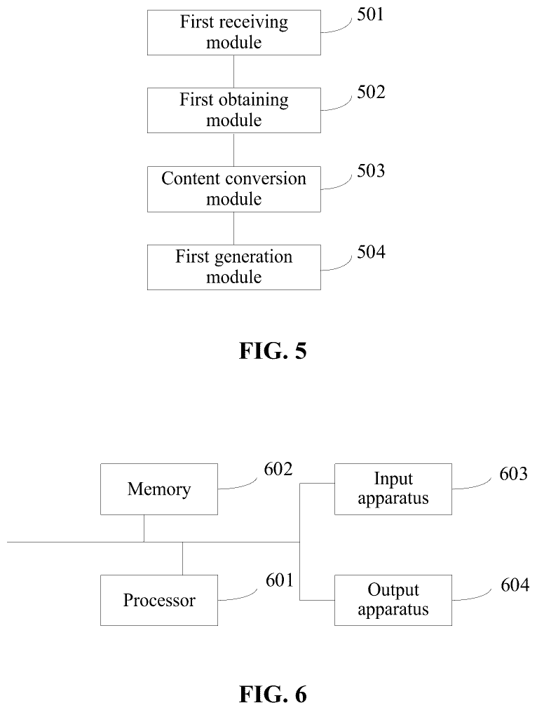

Based on the method embodiment described above, the present disclosure further provides a page generation apparatus. FIG. 5 is a schematic structural diagram of a page generation apparatus according to an embodiment of the present disclosure. The apparatus includes:
a first receiving module 501 configured to receive target description text;
a first obtaining module 502 configured to obtain first description content generated based on the target description text, wherein the first description content conforms to a first target description specification;
a content conversion module 503 configured to convert the first description content to second description content based on a preset relationship between the first target description specification and a second target description specification, wherein the second description content conforms to the second target description specification; and
a first generation module 504 configured to generate a target page based on the second description content.

In an optional implementation, the first obtaining module is specifically configured to:
send the target description text to a server, wherein a target model is deployed on the server, the target model is used for generating the first description content based on the target description text, and the target model is obtained through training using samples conforming to the first target description specification.

In an optional implementation, the content conversion module includes:
a content conversion submodule configured to convert a first description unit in the first description content to first page component description content based on a preset relationship between a description unit corresponding to the first target description specification and page component description content corresponding to the second target description specification, wherein the first page component description content is used for describing a corresponding page component according to the second target description specification; and
a first determining submodule configured to determine the second description content based on the first page component description content.

In an optional implementation, the first generation module includes:
a first display submodule configured to display an initial page based on the second description content;
a second receiving submodule configured to receive a page edit operation for the initial page; and
a second generation submodule configured to generate the target page corresponding to the initial page based on the page edit operation.

In an optional implementation, a plurality of page components are displayed on the initial page, and the second receiving module is specifically configured to:
receive a component edit operation for the plurality of page components on the initial page, wherein the component edit operation includes at least one of a component addition operation, a component deletion operation, and a component adjustment operation.

In an optional implementation, a plurality of page components are displayed on the initial page, and the second receiving module is specifically configured to:
receive an adjustment operation for a target variable of a target page component in the plurality of page components, wherein the target variable is used for displaying the target page component.

In an optional implementation, the apparatus further includes:
a first determining module configured to determine a target application object; and
correspondingly, the first receiving module is specifically configured to:
   receive target description text generated for the target application object, wherein the target description text is used for describing the target application object;
   or, receive target description text input by a user.

In an optional implementation, the apparatus further includes:
a second determining module configured to determine a page display platform, wherein the page display platform is used for displaying the target page; and
correspondingly, the first obtaining module is specifically configured to:
   obtain first description content generated based on the target description text and the page display platform.

In the page generation apparatus according to this embodiment of the present disclosure, the target description text is received; the first description content generated based on the target description text is obtained, wherein the first description content conforms to a first target description specification; the first description content is converted to the second description content based on the preset relationship between the first target description specification and the second target description specification, wherein the second description content conforms to the second target description specification; and the target page is generated based on the second description content.

In this embodiment of the present disclosure, a page generation process is completed by means of generating the first description content based on the target description text and then converting the first description content to the second description content based on which the target page can be generated. It can be learned that, in this embodiment of the present disclosure, a user may complete the generation of the target page simply by inputting the target description text, and there is almost no requirement for the professionalism of page design.

In addition, the manner of intelligently generating pages in this embodiment of the present disclosure obviously improves the efficiency of page generation as compared to the method for completing the construction of pages simply by dragging components in the prior art.

In addition to the method and apparatus described above, an embodiment of the present disclosure further provides a computer-readable storage medium having instructions stored therein. The instructions, when run on a terminal device, cause the terminal device to implement the page generation method described in the embodiments of the present disclosure.

An embodiment of the present disclosure further provides a computer program product including a computer program/instructions. The computer program or instructions, when executed by a processor, cause the page generation method described in the embodiments of the present disclosure to be implemented.

In addition, an embodiment of the present disclosure further provides a page generation device. As shown in FIG. 6, the page generation device may include:
a processor 601, a memory 602, an input apparatus 603, and an output apparatus 604. There may be one or more processors 601 in the page generation device. For example, there is one processor in FIG. 6. In some embodiments of the present disclosure, the processor 601, the memory 602, the input apparatus 603, and the output apparatus 604 may be connected through a bus or in another manner, for example, are connected through the bus in FIG. 6.

The memory 602 may be configured to store a software program and a module. The processor 601 performs various functional applications of the page generation device and processes data by running the software program and the module stored in the memory 602. The memory 602 may mainly include a program storage area and a data storage area. The program storage area may store an operating system, an application required by at least one function, etc. In addition, the memory 602 may include a high-speed random access memory, and may further include a non-volatile memory, such as at least one magnetic disk storage device, a flash memory device, or other volatile solid-state storage devices. The input apparatus 603 may be configured to receive input digital or character information, and generate a signal input related to a user setting and function control of the page generation device.

Specifically, in this embodiment, the processor 601 loads an executable file corresponding to a process of one or more applications into the memory 602 according to the following instructions, and the processor 601 runs the application stored in the memory 602, to implement various functions of the page generation device described above.

It should be noted that the relational terms such as “first” and “second” herein are only used for distinguishing one entity or operation from another, and do not necessarily require or imply that any actual relationship or sequence exists between these entities or operations. Moreover, the terms “include”, “including”, “comprise” and “comprising”, or any of their variants are intended to cover a non-exclusive inclusion, so that a process, method, article, or device that includes a list of elements not only includes those elements but also includes other elements that are not expressly listed, or further includes elements inherent to such process, method, article, or device. In the absence of more restrictions, an element defined by “including/comprising a/an . . . ” does not exclude another identical element in a process, method, article, or device that includes the element.

The above description illustrates merely specific implementations of the present disclosure, so that those skilled in the art can understand or implement the present disclosure. Various modifications to these embodiments are apparent to those skilled in the art, and the general principle defined herein may be practiced in other embodiments without departing from the spirit or scope of the present disclosure. Therefore, the present disclosure will not be limited to the embodiments described herein, but extends to the widest scope that complies with the principles and novelty disclosed in this specification.

1. A page generation method, comprising:
receiving target description text;
obtaining first description content generated based on the target description text, wherein the first description content conforms to a first target description specification;
converting the first description content to second description content based on a preset relationship between the first target description specification and a second target description specification, wherein the second description content conforms to the second target description specification; and
generating a target page based on the second description content.

2. The method according to claim 1, wherein obtaining the first description content generated based on the target description text comprises:
sending the target description text to a server, wherein a target model is deployed on the server, the target model is used for generating the first description content based on the target description text, and the target model is obtained through training using samples conforming to the first target description specification.

3. The method according to claim 1, wherein converting the first description content to the second description content based on the preset relationship between the first target description specification and the second target description specification comprises:
converting a first description unit in the first description content to first page component description content based on a preset relationship between a description unit corresponding to the first target description specification and page component description content corresponding to the second target description specification, wherein the first page component description content is used for describing a corresponding page component according to the second target description specification; and
determining the second description content based on the first page component description content.

4. The method according to claim 1, wherein generating the target page based on the second description content comprises:
displaying an initial page based on the second description content;
receiving a page edit operation for the initial page; and
generating the target page corresponding to the initial page based on the page edit operation.

5. The method according to claim 4, wherein a plurality of page components are displayed on the initial page, and receiving the page edit operation for the initial page comprises:
receiving a component edit operation for the plurality of page components on the initial page, wherein the component edit operation comprises at least one of a component addition operation, a component deletion operation, and a component adjustment operation.

6. The method according to claim 4, wherein a plurality of page components are displayed on the initial page, and receiving the page edit operation for the initial page comprises:
receiving an adjustment operation for a target variable of a target page component in the plurality of page components, wherein the target variable is used for displaying the target page component.

7. The method according to claim 1, wherein before receiving the target description text, the method further comprises:
determining a target application object; and
correspondingly, receiving the target description text comprises:
receiving target description text generated for the target application object, wherein the target description text is used for describing the target application object;
or, receiving target description text input by a user.

8. The method according to claim 1, wherein before obtaining the first description content generated based on the target description text, the method further comprises:
determining a page display platform, wherein the page display platform is used for displaying the target page; and
correspondingly, obtaining the first description content generated based on the target description text comprises:
obtaining first description content generated based on the target description text and the page display platform.

9. (canceled)

10. A non-transitory computer-readable storage medium having instructions stored therein, wherein the instructions, when run on a terminal device, cause the terminal device to implement a page generation method comprising:
receiving target description text;
obtaining first description content generated based on the target description text, wherein the first description content conforms to a first target description specification;
converting the first description content to second description content based on a preset relationship between the first target description specification and a second target description specification, wherein the second description content conforms to the second target description specification; and
generating a target page based on the second description content.

11. (canceled)

12. (canceled)

13. The non-transitory computer-readable storage medium according to claim 10, wherein obtaining the first description content generated based on the target description text comprises:
sending the target description text to a server, wherein a target model is deployed on the server, the target model is used for generating the first description content based on the target description text, and the target model is obtained through training using samples conforming to the first target description specification.

14. The non-transitory computer-readable storage medium according to claim 10, wherein converting the first description content to the second description content based on the preset relationship between the first target description specification and the second target description specification comprises:
converting a first description unit in the first description content to first page component description content based on a preset relationship between a description unit corresponding to the first target description specification and page component description content corresponding to the second target description specification, wherein the first page component description content is used for describing a corresponding page component according to the second target description specification; and
determining the second description content based on the first page component description content.

15. The non-transitory computer-readable storage medium according to claim 10, wherein generating the target page based on the second description content comprises:
displaying an initial page based on the second description content;
receiving a page edit operation for the initial page; and
generating the target page corresponding to the initial page based on the page edit operation.

16. The non-transitory computer-readable storage medium according to claim 14, wherein a plurality of page components are displayed on the initial page, and receiving the page edit operation for the initial page comprises:
receiving a component edit operation for the plurality of page components on the initial page, wherein the component edit operation comprises at least one of a component addition operation, a component deletion operation, and a component adjustment operation.

17. The non-transitory computer-readable storage medium according to claim 14, wherein a plurality of page components are displayed on the initial page, and receiving the page edit operation for the initial page comprises:
receiving an adjustment operation for a target variable of a target page component in the plurality of page components, wherein the target variable is used for displaying the target page component.

18. The non-transitory computer-readable storage medium according to claim 10, wherein before receiving the target description text, the method further comprises:
determining a target application object; and
correspondingly, receiving the target description text comprises:
receiving target description text generated for the target application object, wherein the target description text is used for describing the target application object;
or, receiving target description text input by a user.

19. The non-transitory computer-readable storage medium according to claim 10, wherein before obtaining the first description content generated based on the target description text, the method further comprises:
determining a page display platform, wherein the page display platform is used for displaying the target page; and
correspondingly, obtaining the first description content generated based on the target description text comprises:
obtaining first description content generated based on the target description text and the page display platform.

20. A page generation device, comprising: a memory, a processor, and a computer program stored on the memory and executable on the processor, wherein the processor, when executing the computer program, implements a page generation method comprising:
receiving target description text;
obtaining first description content generated based on the target description text, wherein the first description content conforms to a first target description specification;
converting the first description content to second description content based on a preset relationship between the first target description specification and a second target description specification, wherein the second description content conforms to the second target description specification; and
generating a target page based on the second description content.

21. The page generation device according to claim 20, wherein obtaining the first description content generated based on the target description text comprises:
sending the target description text to a server, wherein a target model is deployed on the server, the target model is used for generating the first description content based on the target description text, and the target model is obtained through training using samples conforming to the first target description specification.

22. The page generation device according to claim 20, wherein converting the first description content to the second description content based on the preset relationship between the first target description specification and the second target description specification comprises:
converting a first description unit in the first description content to first page component description content based on a preset relationship between a description unit corresponding to the first target description specification and page component description content corresponding to the second target description specification, wherein the first page component description content is used for describing a corresponding page component according to the second target description specification; and
determining the second description content based on the first page component description content.

23. The page generation device according to claim 20, wherein generating the target page based on the second description content comprises:
displaying an initial page based on the second description content;
receiving a page edit operation for the initial page; and
generating the target page corresponding to the initial page based on the page edit operation.
